(19) United States
(12) Patent Application Publication
(10) Pub. No.: US 2025/0243434 A1
(43) Pub. Date: Jul. 31, 2025

(54) METHOD FOR MANUFACTURING A DETERGENT PORTION UNIT

(71) Applicant: HENKEL AG & CO. KGAA, Düsseldorf (DE)

(72) Inventors: Matthias SUNDER, Düsseldorf (DE); Friedhelm SIEPMANN, Essen (DE); Lena KOEGEL, Krefeld (DE)

(21) Appl. No.: 18/853,934

(22) PCT Filed: Jan. 19, 2023
(86) PCT No.: PCT/EP2023/051170

§ 371 Date: Oct. 3, 2024

(30) Foreign Application Priority Data
Apr. 13, 2022 (DE) 10 2022 203 711.1

(51) Int. Cl. C11D 11/00; C11D 3/22; C11D 3/43; C11D 17/00

(52) U.S. Cl. CPC C11D 11/0094; C11D 3/221; C11D 3/43; C11D 17/003

(57) ABSTRACT

A method for manufacturing a detergent portion unit including a dimensionally stable gel. A mixture of a detergent and a gelling agent is provided and fed to a shaping device, such that the mixture is at least partially solidified in the shaping device and a solid gel strand is discharged. The strand is transported using a transport device and the solid gel strand is cut to length using an ultrasonic blade to form the solid gel unit.

The present invention relates to a method for manufacturing a detergent portion unit, comprising a solid gel.

Continuously changing requirements are placed on the forms of manufacture and supply of washing and cleaning agents. The main focus has, for quite some time, been on the convenient dosing of detergents and cleaning agents by the consumer and the simplification of the work steps necessary for carrying out a washing or cleaning method. One technical solution is provided by pre-portioned washing or cleaning agents, for example, water-soluble containers having one or more receiving compartments for powdered or liquid detergents or cleaning agents. A further technical solution is provided by detergent tablets which can have a single-phase or multi-phase design.

To produce the water-soluble containers, water-soluble polymers are generally deformed to form receiving chambers, which are subsequently filled with a detergent or cleaning agent and finally closed. The receiving chambers can be produced, for example, from water-soluble polymer films by means of deep-drawing methods. In an alternative embodiment of the method, a water-soluble polymer is deformed by means of injection molding to form a receptacle.

The water-soluble packaging material used for packaging the filled detergent portion units is generally hygroscopic. In the context of the production, packaging, storage, and subsequent use by the consumer, the water absorption tendency and water absorption capacity of the packaging means can cause the portion units to adhere to surfaces of machines or packaging means and not be able to be conveyed optimally, or adjacent portion units, e.g., in a common outer packaging, to adhere to one another. To avoid this adhesion tendency of the water-soluble portion units, it is possible to modify the surface properties thereof by applying a powder agent. The powdering of the water-soluble detergent portion units in turn requires an additional method step.

The water-soluble packaging materials used are generally not washing active or cleaning active, i.e., do not contribute to the product performance. The reduction in the amount of packaging with respect to the total weight of the detergent portion units would thus not result in loss of performance and would be welcomed on the grounds of sustainability and economic efficiency.

Finally, the washing performance provided by the detergent portion unit is directly related to the dissolution properties of the portion unit. Particularly with regard to the increasing use of cold washing methods, it is preferred to keep the thickness of the water-soluble film material contained in the detergent portion unit as low as possible in order to accelerate the dissolution process. However, the reduction in the thickness of the surrounding film material simultaneously requires a reduced mechanical stability of the portion units. Overcoming this apparent dichotomy of mechanical stability and dissolution rate of detergent portion units packaged using water-soluble films is still a relevant aspect in the development of water-soluble detergent portion units.

Detergent tablets, in which, however, sufficient mechanical stability and a high dissolution rate are irreconcilably opposed in a similar manner as in the case of the sachets, offer an alternative to the previously described sachets.

Multi-phase detergent portion units, for example in the form of core tablets, which in addition to a tableted body comprise wax or gel phases, offer an alternative to completely compressed detergent tablets. Thus, European patent EP 1 032 642 B1 describes, for example, detergent tablets comprising a compressed phase and an uncompressed gel phase and a method for the manufacturing thereof.

Against the background of the prior art described above, the object of the application was that of providing efficient methods for manufacturing fast-dissolving detergent portion units that have high product and storage stability, can be packaged in a simple manner using minimal amounts of additional packaging materials, and appeal to the consumer based on an attractive olfactory, visual, and/or tactile experience. The detergent portion units should have a high product performance and be easy and safe to handle for the consumer.

A first subject matter of the application is a method for manufacturing a detergent portion unit comprising a dimensionally stable solid gel, comprising the steps of:
i) providing a detergent-containing and gelling agent-containing mixture;
ii) feeding the detergent-containing and gelling agent-containing mixture to a shaping device;
iii) passing the detergent-containing and gelling agent-containing mixture through the shaping device such that the surfactant-containing and gelling agent-containing mixture is at least partially solidified in the shaping device and a solid gel strand is formed;
iv) discharging the solid gel strand from the shaping device and further transporting said strand by means of a transport device comprising:
   a) at least one movable conveying element;
v) cutting the solid gel strand to length by means of ultrasonic cutting such that a solid gel is formed.

The term “detergent portion unit” describes a supply form in which a measured portion of a detergent or cleaning agent is present. Detergent portion units consequently refer both to supply forms for textile laundry and to supply forms for cleaning hard surfaces such as ceramics, glass, metal, or tiles. The detergent portion unit preferably has a weight of 14 g to 42 g, preferably of 18 g to 38 g, in particular of 20 g to 34 g.

The detergent portion unit comprises a solid gel. The detergent portion unit can consist of the solid gel. In this case, the solid gel preferably has a weight of 14 g to 42 g, more preferably of 18 g to 38 g, in particular of 20 g to 34 g. If the detergent portion unit comprises further constituents in addition to the solid gel, the weight of the solid gel is preferably 10 g to 28 g, preferably 12 g to 23 g and in particular 15 g to 20 g.

Bodies which exhibit elastic deformation behavior under the action of force are referred to as solid gel. Bodies are considered dimensionally stable if they have an inherent dimensional stability that enables them to assume a non-disintegrating three-dimensional shape under the usual conditions of manufacture, storage, transport and handling by the consumer, this three-dimensional shape also not changing under the conditions mentioned over an extended period of time, preferably 4 weeks, particularly preferably 8 weeks and in particular 32 weeks, i.e., under the usual conditions of manufacture, storage, transport and handling by the consumer, the body remains in the three-dimensional geometric shape created during manufacture, i.e., it does not dissolve.

The method is particularly suitable for the packaging of solid gel having a high surfactant content. In preferred embodiments, the detergent-containing and gelling agent-containing mixture contains, based on the total weight thereof, 20 to 60 wt. %, preferably 25 to 55 wt. % and in particular 30 to 50 wt. % surfactant.

In terms of the manufacturability and the subsequent dissolving power of the solid gels, it has proven advantageous for them to contain 15 to 35 wt. %, preferably 20 to 30 wt. %, of an aqueous-organic solvent. Accordingly, preferred detergent-containing and gelling agent-containing mixtures also contain, based on the total weight thereof, 15 to 35 wt. %, preferably 20 to 30 wt. %, of an aqueous-organic solvent.

Preferred solid gels further contain dye.

Preferred solid gels are transparent. Such solid gels are referred to as “transparent” if they have a transmission above 50%, preferably above 60% and in particular above 80%, in the wavelength range of from 410 to 800 nm at at least one wavelength, preferably at 600 nm. The transmission is determined by means of VIS spectrometry at a sample temperature of 20° C. and a cuvette length of 10 mm.

For the manufacture and later storage and transport properties of the solid gels, it has proven advantageous to use low-molecular-weight gelling agents having a molar mass of up to 2000 g/mol in the solid gel, wherein the weight proportion thereof with respect to the total weight of the solid gel is preferably less than 5 wt. %, preferably 0.1 to 5 wt. %, and particularly preferably 0.1 to 2.5 wt. %. In addition, the advantages of the method according to the invention come to bear in particular in the processing of said low-molecular-weight gelling agents with their specific gelling properties, which is why it is further preferred if the detergent-containing and gelling agent-containing mixture contains low-molecular-weight gelling agents having a molar mass of up to 2000 g/mol, wherein the weight proportion thereof with respect to the total weight of the mixture is preferably less than 5 wt. %, preferably 0.1 to 5 wt. %, particularly preferably 0.1 to 2.5 wt. %.

In a preferred embodiment, the low-molecular-weight gelling agent has a solubility in water of less than 0.1 g/L (20° C.). The solubility of the organic gelator compound is determined at 20° C. in double-distilled, demineralized water.

Furthermore, gelling agents are preferably suitable which have a structure containing at least one hydrocarbon structural unit having 6 to 20 carbon atoms (preferably at least one carbocyclic, aromatic structural unit) and additionally an organic structural unit covalently bonded to the aforementioned hydrocarbon unit and having at least two groups selected from —OH, —NH—, or mixtures thereof.

Particularly preferred solid gels are characterized in that said solid gels contain at least one benzylidene alditol compound of formula (GB-I) as gelling agent

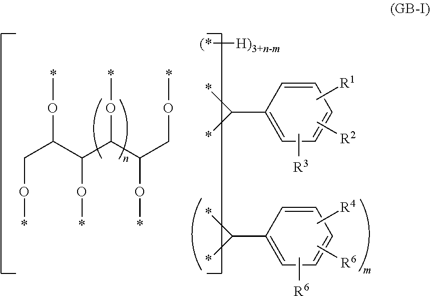

wherein
*- represents a single covalent bond between an oxygen atom of the alditol backbone and the provided functional group,
n represents 0 or 1, preferably 1,
m represents 0 or 1, preferably 1,
R¹, R² and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵ and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy C₂-C₄ alkyl group, with two of the functional groups forming, together with the remainder of the molecule, a 5-membered or 6-membered ring.

Due to the stereochemistry of the alditols, it should be mentioned that said benzylidene alditols according to the invention are suitable in the L configuration or in the D configuration or in a mixture of the two. Due to natural availability, the benzylidene alditol compounds are preferably used according to the invention in the D configuration. It has proven preferable if the alditol backbone of the benzylidene alditol compound according to formula (GB-I) contained in the shaped body is derived from D-glucitol, D-mannitol, D-arabinitol, D-ribitol, D-xylitol, L-glucitol, L-mannitol, L-arabinitol, L-ribitol or L-xylitol.

Particularly preferred are those solid gels which are characterized in that R¹, R², R³, R⁴, R⁵ and R⁶ according to the benzylidene alditol compound of formula (GB-I) mean, independently of one another, a hydrogen atom, methyl, ethyl, chlorine, fluorine, or methoxy, preferably a hydrogen atom.
n according to the benzylidene alditol compound of formula (GB-I) preferably represents 1.
m according to the benzylidene alditol compound of formula (GB-I) preferably represents 1.

The solid gel very particularly preferably contains at least one compound of formula (GB-I1) as the benzylidene alditol compound of formula (GB-I)

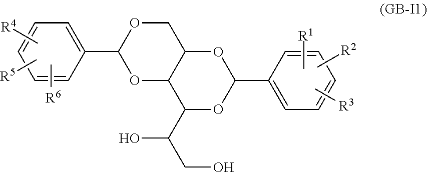

where R¹, R², R³, R⁴, R⁵ and R⁶ are as defined in formula (I). Most preferably, according to formula (GB-I1), R¹, R², R³, R⁴, R⁵ and R⁶ represent, independently of one another, a hydrogen atom, methyl, ethyl, chlorine, fluorine, or methoxy, preferably a hydrogen atom.

Most preferably, the benzylidene alditol compound of formula (GB-I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol or mixtures thereof.

Preferred solid gels contain at least one 2,5-diketopiperazine compound of formula (GB-II) as the gelling agent

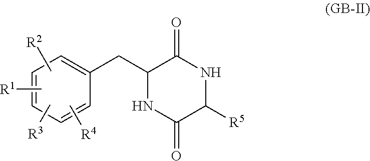

wherein
R¹, R², R³ and R⁴ represent, independently of one another, a hydrogen atom, a hydroxyl group, a (C₁-C₆) alkyl group, a (C₂-C₆) alkenyl group, a (C₂-C₆)) acyl group, a (C₂-C₆) acyloxy group, a (C₁-C₆) alkoxy group, an amino group, a (C₂-C₆) acylamino group, a (C₁-C₆) alkylaminocarbonyl group, an aryl group, an aroyl group, an aroyloxy group, an aryloxy group, an aryl-(C₁-C₄) alkyloxy group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, a carboxy-(C₁-C₃) alkyl group, where at least two of the functional groups R¹ to R⁴ can form, together with the remainder of the molecule, a 5-membered or 6-membered ring,
R⁵ represents a hydrogen atom, a linear (C₁ to C₆) alkyl group, a branched (C₃ to C₁₀) alkyl group, a (C₃ to C₆) cycloalkyl group, a (C₂-C₆) alkenyl group, a (C₂-C₆) alkynyl group, a (C₁-C₄) hydroxyalkyl group, a (C₁-C₄) alkoxy-(C₁-C₄) alkyl group, a (C₁-C₄) acyloxy-(C₁-C₄) alkyl group, an aryloxy-(C₁-C₄) alkyl group, an O-(aryl-(C₁-C₄) alkyl)oxy-(C₁-C₄) alkyl group, a (C₁-C₄) alkylsulfanyl-(C₁-C₄) alkyl group, an aryl group, an aryl-(C₁-C₃) alkyl group, a heteroaryl group, a heteroaryl-(C₁-C₃) alkyl group, a (C₁-C₄) hydroxyalkyl group, a (C₁-C₄) aminoalkyl group, an N—(C₁-C₄) alkylamino-(C₁-C₄) alkyl group, an N,N—(C₁-C₄) dialkylamino-(C₁-C₄) alkyl group, an N—(C₂-C₈) acylamino-(C₁-C₄) alkyl group, an N—(C₂-C₈) acyl-N—(C₁-C₄) alkylamino-(C₁-C₄) alkyl group, an N—(C₂-C₈) aroyl-N—(C₁-C₄) alkylamino-(C₁-C₄) alkyl group, an N,N—(C₂-C₈) diacylamino-(C₁-C₄) alkyl group, an N-(aryl-(C₁-C₄) alkyl)amino-(C₁-C₄) alkyl group, an N,N-di(aryl-(C₁-C₄) alkyl)amino-(C₁-C₄) alkyl group, a (C₁-C₄) carboxyalkyl group, a (C₁-C₄) alkoxycarbonyl-(C₁-C₃) alkyl group, a (C₁-C₄) acyloxy-(C₁-C₃) alkyl group, a guanidino-(C₁-C₃) alkyl group, an aminocarbonyl(C₁-C₄) alkyl group, an N—(C₁-C₄) alkylaminocarbonyl-(C₁-C₄) alkyl group, an N,N-di((C₁-C₄) alkyl)aminocarbonyl-(C₁-C₄) alkyl group, an N—(C₂-C₈) acylaminocarbonyl-(C₁-C₄) alkyl group, an N,N—(C₂-C₈) diacylaminocarbonyl-(C₁-C₄) alkyl group, an N—(C₂-C₈) acyl-N—(C₁-C₄) alkylaminocarbonyl-(C₁-C₄) alkyl group, an N-(aryl-(C₁-C₄) alkyl)aminocarbonyl-(C₁-C₄) alkyl group, an N-(aryl-(C₁-C₄) alkyl)-N—(C₁-C₆) alkylaminocarbonyl-(C₁-C₄) alkyl group or an N,N-di(aryl-(C₁-C₄) alkyl)aminocarbonyl-(C₁-C₄) alkyl group.

It is preferred according to the invention if R³ and R⁴ according to formula (GB-II) represent a hydrogen atom. It is particularly preferred according to the invention if R², R³ and R⁴ according to formula (GB-II) represent a hydrogen atom. Therefore, particularly preferred shaped bodies according to the invention contain at least one 2,5-diketopiperazine compound according to formula (GB-IIa)

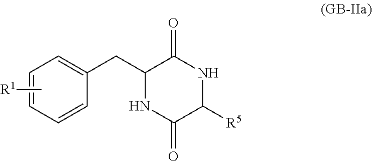

where R¹ and R⁵ are as defined under formula (GB-II) (vide supra).

It has been found to be preferred if the functional group R¹ according to formula (GB-II) and according to formula (GB-IIa) binds in the para position of the phenyl ring. Within the meaning of the present invention, such shaped bodies according to the invention are preferred which contain at least one 2,5-diketopiperazine compound according to formula (GB-IIb),

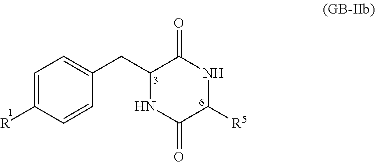

where R¹ and R⁵ are as defined under formula (GB-II) (vide supra). The numbers 3 and 6 positioned on the ring atoms in formula (GB-IIb) only mark positions 3 and 6 of the diketopiperazine ring, as they are generally used in the scope of the invention for naming all 2,5-diketopiperazines according to the invention.

The 2,5-diketopiperazine compounds of formula (GB-II) have centers of chirality at least on the carbon atoms in positions 3 and 6 of the 2,5-diketopiperazine ring. The numbering of ring positions 3 and 6 was illustrated by way of example in formula (GB-IIb). The 2,5-diketopiperazine compound of formula (GB-II) of the composition according to the invention is preferably, based on the stereochemistry of the carbon atoms at the 3 and 6 position of the 2,5-diketopiperazine ring, the configuration isomer 3S,6S, 3R,6S, 3S,6R, 3R,6R, or mixtures thereof, particularly preferably 3S,6S.

Preferred solid gels contain at least one 2,5-diketopiperazine compound of formula (GB-II) as the gelling agent, selected from 3-benzyl-6-carboxyethyl-2,5-diketopiperazine, 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di(benzyl)-2,5-diketopiperazine, 3,6-di(p-hydroxybenzyl)-2,5-diketopiperazine, 3,6-di(p-(benzyloxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine or mixtures thereof. In turn, compounds having the aforementioned configuration isomers are preferably suitable for selection.

It is also possible for the solid gels according to the invention to contain at least one diarylamidocystine compound of formula (GB-III) as the gelling agent a)

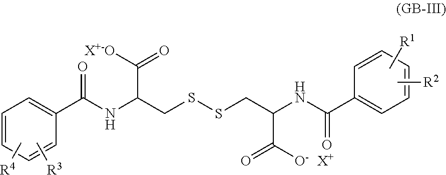

wherein
X⁺ represents, independently, a hydrogen atom or an equivalent of a cation,
R¹, R², R³, and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, an amino group, an N—(C₁-C₄-alkyl)amino group, an N,N-Di(C₁-C₄-alkyl)amino group, an N—(C₂-C₄-hydroxyalkyl)amino group, an N,N-Di(C₂-C₄-hydroxyalkyl)amino group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, hydroxyl group, amino group, N—(C₁-C₄-alkyl)amino group, N,N-Di(C₁-C₄-alkyl)amino group, N—(C₂-C₄-hydroxyalkyl)amino group, N,N-Di(C₂-C₄-hydroxyalkyl)amino group.

Each of the stereocenters contained in the compound of formula (GB-III) can represent, independently of one another, the L or D stereoisomer. It is preferable according to the invention for the above-mentioned cystine compound of formula (GB-III) to be derived from the L stereoisomer of the cysteine.

The above-mentioned solid gels can contain at least one compound of formula (GB-III), in which R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, or hydroxyl group. In particular, those shaped bodies which contain N,N′-dibenzoylcystine (R¹═R²=R³═R⁴=hydrogen atom; X³⁰=independently of one another, a hydrogen atom or an equivalent of a cation), in particular N,N′-dibenzoyl-L-cystine, as a diarylamidocystine compound of formula (GB-III) are particularly suitable.

The N—(C₈-C₂₄) hydrocarbylglyconamide compounds suitable as the gelling agent a) preferably have the formula (GB-IV)

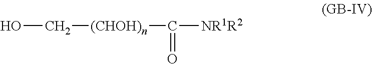

where
n is 2 to 4, preferably 3 or 4, in particular 4;
R¹ is selected from hydrogen, C₁-C₁₆ alkyl functional groups, C₁-C₃ hydroxy or methoxyalkyl functional groups, preferably C₁-C₃ alkyl, hydroxyalkyl or methoxyalkyl functional groups, particularly preferably methyl;
R² is selected from C₈-C₂₄ alkyl radicals, C₈-C₂₄ monoalkenyl radicals, C₈-C₂₄ dialkenyl radicals, C₈-C₂₄ trialkenyl radicals, C₈-C₂₄ hydroxyalkyl radicals, C₈-C₂₄-hydroxyalkenyl residues, C₁-C₃ hydroxyalkyl residues or methoxy-C₁-C₃-alkyl residues, preferably C₈-C₁₈ alkyl residues and mixtures thereof, more preferably C₈, C₁₀, C₁₂, C₁₄, C₁₆, and C₁₈ alkyl radicals and mixtures thereof, most preferably C₁₂ and C₁₄ alkyl radicals or a mixture thereof.

In particularly preferred embodiments, the functional group

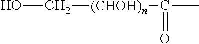

is a functional group derived from a glycuronic acid, in particular the glycuronic acid of a hexose (n=4). In particular, glucuronic acid should be mentioned as a preferred functional group. R¹ is preferably H or a short-chain alkyl functional group, in particular methyl. R² is preferably a long-chain alkyl functional group, for example a C₈-C₁₈ alkyl functional group.

Compounds of formula (GB-IV1) are therefore very particularly preferred

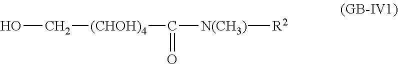

where R² has the meanings given for formula (GB-IV).

In a particularly preferred embodiment, the at least one low-molecular-weight gelling agent in the detergent-containing and gelling agent-containing mixture is selected from the group consisting of the group of cyclic dipeptides, cyclic dipeptide derivatives and dibenzylidene sorbitols. The at least one gelling agent in the detergent-containing and gelling agent-containing mixture is more particularly preferably dibenzylidene sorbitol (DBS) because of its technical effect.

The detergent-containing and gelling agent-containing mixture is provided in step i) of the method. This mixture can be prepared continuously or discontinuously, wherein continuous preparation is preferred due to the resulting process efficiency. The mixture can be provided, for example, by means of a mixer. Static and dynamic mixers are suitable as mixing elements.

The detergent-containing and gelling agent-containing mixture preferably has a temperature above 23° C., preferably in the range of 23° C. to 60° C.

Like method step i), the feeding of the detergent-containing and gelling agent-containing mixture to the shaping device is also preferably carried out continuously in step ii).

The detergent-containing and gelling agent-containing mixture is preferably introduced into the shaping device at a filling rate of 20 ml/s to 800 ml/s.

In a preferred embodiment, the detergent-containing and gelling agent-containing mixture is also continuously passed through the shaping device in step iii).

The devices known to the person skilled in the art for forming shaped strands are suitable as a shaping device. A method is particularly preferred in the course of which the mixture is continuously pressed out of a shaping opening under pressure.

The shaping device can be designed as a structurally separate device. Alternatively, the shaping device can be integrated structurally into a mixer which provides the detergent-containing and gelling agent-containing mixture.

In its simplest embodiment, a sufficiently stable outlet opening is used as the shaping device. The opening area of this outlet opening determines the cross sectional area of the exiting extruded strand.

In a further developed embodiment, the shaping device is designed as a tube, the one end of which serves as an inlet opening for the detergent-containing and gelling agent-containing mixture and the other end of which serves as an outlet opening for the extruded strand. Again, the opening area of the outlet opening determines the cross sectional area of the exiting extruded strand. The opening area of the tube and its cross sectional area are preferably identical.

In a further development, the shaping device comprises a pipe and an outlet nozzle replaceably connected to said pipe.

If the shaping device and the device by means of which the detergent-containing and gelling agent-containing mixture is provided are designed as separate devices, the detergent-containing and gelling agent-containing mixture is preferably guided through a supply line after exiting the last-mentioned device and before entering the shaping device.

If the detergent-containing and gelling agent-containing mixture is guided through a supply line after being provided and before entering the shaping device, the cross sectional area of the supply line can be identical to or differ from the cross sectional area of the outlet opening of the shaping device. If the cross sectional area of the supply line is smaller than the cross sectional area of the outlet opening of the shaping device, the flow velocity of the detergent-containing and gelling agent-containing mixture is lower when exiting the supply line into the shaping device than when exiting the shaping device. The opposite is true in the cases in which the cross sectional area of the supply line is greater than the cross sectional area of the shaping device. The realizing of different flow speeds in the supply line and shaping device allows the curing behavior of the detergent-containing and gelling agent-containing mixture to be suitably influenced.

The time period between the provision of the detergent-containing and gelling agent-containing mixture and its entry into the shaping device is preferably 1 to 20 seconds, particularly preferably 5 to 40 seconds. This applies in particular to embodiments of the method in which the mixing device and shaping device are designed separately.

In order to accelerate solidification or to facilitate further packaging, the detergent-containing and gelling agent-containing mixture is preferably cooled in step iii). The cooling preferably takes place under defined climatic conditions in which, in addition to the temperature, the humidity in the process chamber is also controlled and regulated, for example.

The solid gel strand is preferably discharged continuously from the shaping device in step iv).

Following the discharge, the solid gel strand is transported further by means of a transport device. Here, the transport device moves the solid gel strand preferably at a speed of 0.05 m/s to 3 m/s, particularly preferably of 0.8 to 2.2 m/s.

The transport device used comprises at least one movable conveying element. Suitable conveying elements are, for example, continuous or lamellar conveyor belts or roller conveyors, wherein the use of continuous conveyor belts is particularly preferred. In particular, the use of modular conveyor belts based on conveyor chain links is preferred.

In a preferred method variant, the transport device further comprises, in addition to the conveying element,
b) two side elements opposite one another and synchronously movable with the movable conveying element,
   wherein
the conveying element and the side elements form a conveying path on which the solid gel strand is moved by means of the conveying element and is laterally delimited by means of the side element, and
the side elements have embossing elements which project into the conveying path and emboss the surface of the solid gel strand after the solid gel strand has been discharged from the shaping device.

The side elements laterally delimiting the conveying path are preferably movable synchronously with the conveying element and synchronously with one another.

The embossing elements of the two side elements are preferably arranged opposite one another. Preferred side elements have replaceable embossing elements. The use of replaceable embossing elements increases the method efficiency, for example in connection with the cleaning of the method device or when changing product formats.

For the process control and the effective embossing of the solid gel strand, it has proven to be advantageous if, when the conveying path has a width b that is defined orthogonally to the conveying direction, the solid gel strand has a width, preferably from 0.85 b to 1 b, in particular from 0.95 b to 1 b, that is orthogonal to the conveying direction and parallel to the transport surface.

For the same reasons, it is preferred if the conveying path has a width b that is orthogonal to the conveying direction, and the embossing elements project orthogonally to the conveying direction from 0.05 b to 0.5 b, preferably from 0.1 b to 0.4 b, particularly preferably from 0.15 b to 0.3 b, into the conveying path.

In order to achieve a stable embossing, it is furthermore preferred for the embossing elements, when the height of the solid gel strand is orthogonal to the transport surface, to have a height of 0.8 h to 4 h, preferably of 1 h to 3 h, and in particular of 1.1 to 2 h, orthogonal to the transport surface.

The embossing elements can be designed in various ways, wherein the surface of the embossing elements, however, is preferably smooth to avoid adhesion, and does not have any notches or undercuts.

Embossing elements which taper at least partially in a spatial direction orthogonal to the side elements and parallel to the transport surface have proven to be particularly effective. Preferably, embossing elements are in particular designed to have a triangular cross section plane parallel to the transport surface.

In a particularly preferred embodiment, the embossing elements have a triangular cross section parallel to the transport surface, comprising a base side parallel to its corresponding side element and two isosceles legs. The use of embossing elements, which have a triangular cross section parallel to the transport surface and a base side parallel to its corresponding side element and two concave isosceles legs, is very particularly preferred.

The embossing elements are preferably pulled out of the solid gel strand after a period of 1 to 50 seconds, preferably of 1 to 25 seconds, and in particular of 1 to 15 seconds.

The extruded strand exiting the shaping device is cut to length by ultrasonic cutting to form individual solid gels in step v). When the embossing elements described above are used, the solid gel strand is preferably cut to length in the region of the embossing.

Ultrasonic cutting has surprisingly proven to be an efficient and reliable method for cutting the detergent-containing and gelling agent-containing solid gel strand, even at a high throughput.

The ultrasonic blade is guided through the solid gel strand preferably in a direction orthogonal to the conveying direction of the transport device in order to cut the solid gel strand. It is particularly preferred to guide the ultrasonic blade through the solid gel strand in a direction orthogonal to the underside of the solid gel strand. In a corresponding procedure, the ultrasonic blade is guided from the upper side to the underside of the solid gel strand resting on the conveying element.

In an alternative procedure, the ultrasonic blade is guided through the solid gel strand in a direction parallel to the underside of the solid gel strand. In the context of such a method embodiment, the ultrasonic blade is guided from one side surface to the opposite side surface of the solid gel strand. The upper side and underside of the solid gel strand are simultaneously cut through.

The cutting edge of the ultrasonic blade can be designed in various ways. However, ultrasonic blades which have a straight blade are preferred in particular. To this end, the use of ultrasonic blades with a curved cutting edge represents an alternative due to the plurality of possible three-dimensional shapes of the cut-to-length solid gels, but straight cutting edges are preferred due to their higher process efficiency.

Depending on the design of the ultrasonic blades used, the cut edges obtained by the ultrasonic cutting can, for example, have the shape of a plane or a curved surface.

The three-dimensional shape of the solid gel is basically freely selectable; its side surfaces can, for example, be designed to be convex, concave or planar. At the same time, however, certain spatial configurations have proven to be particularly advantageous against the background of the manufacturability, storage, and use of the solid gels.

In correspondingly advantageous detergent portion units, the solid gel comprises a flat underside, the largest diagonal of which is greater than the height of the solid gel. Not only can these bodies be manufactured in a simple manner, for example by means of casting methods, but they can also be packaged in a simple and space-saving manner and are suitable for dosing via the dosing or dispensing chambers of electronic cleaning devices. It is particularly preferred if the solid gel has a flat underside, the largest diagonal of which is more than 1.5 times, preferably more than twice the height of the solid gel.

For manufacturability, for example in relation to the removal of the solid gel from a casting mold, it has proven to be advantageous if the underside of the solid gel does not have any corners. Preferred solid gels are therefore characterized by oval undersides or alternatively by ellipsoidal or round, preferably round, undersides. Corresponding solid gels with non-angular undersides are also preferred by many consumers due to their optics. For example, such solid gels having an underside and an upper side which are connected to one another by a cylindrical lateral surface are therefore preferred.

Advantages in relation to the use of space during manufacture and packaging are realized by angular undersides. If the solid gels are molded, for example, in the form of plates, which are subsequently cut into solid gels, angular undersides are advantageous since such solid gels can be cut without any residual amounts occurring and can be packaged in a space-saving manner. In an alternative embodiment, preferred solid gels therefore have angular undersides, in particular triangular, square or hexagonal undersides. For further processing or packaging, it can be advantageous if the solid gel has an angular underside with rounded corners.

With regard to the manufacture, packaging, and use of the detergent portion units, it has also proven to be advantageous if the solid gels have an upper side plane parallel to the underside.

In a first preferred geometric embodiment, the solid gel has an underside and an upper side which have the same geometric shape, wherein the underside and the upper side have the same surface size. As already described above, corresponding solid gels can be produced in a simple manner, for example by casting plates and subsequently cutting the plates into individual solid gels. In addition, in any subsequent method steps, said solid gels can be spatially aligned during packaging or use by the user due to the geometric identity of the underside and upper side as solid gels with reduced body symmetry. This applies in particular to solid gels which at the same time have a upper side plane parallel to the underside. Examples of such solid gels are circular cylinders, elliptical cylinders, parallelepipeds, rhomboids, straight or oblique prisms, cuboids or cubes. The group of circular cylinders and elliptical cylinders in turn includes vertical circular cylinders and elliptical cylinders as well as the inclined circular cylinders and elliptical cylinders. Due to their simple production by isolation from a plate, solid gels in the form of vertical circular cylinders, vertical elliptical cylinders, straight prisms, straight cuboids or cubes are preferred.

In an alternative embodiment, the solid gel has an underside and an upper side which have the same geometric shape, wherein the underside and the upper side have different surface sizes. Corresponding solid gels can be preferred due to their attractive appearance or their optimized fit while simultaneously being comparatively simple to manufacture. Examples of such solid gels include circular cylinders or elliptical cylinders with a convex or concave underside and a planar upper side. Further examples include truncated cones or truncated pyramids.

In summary, preferred subject matters of the application can be characterized as detergent portion units comprising a solid gel having an underside and an upper side, wherein the surface of the upper side amounts to 80 to 100%, preferably 90 to 100%, and in particular 98 to 100% of the underside.

In order to manufacture detergent portion units which comprise further components in addition to the solid gel, a procedure is suitable in which the solid gel is bonded to a prefabricated shaped body.

In a preferred method variant, the discharged solid gel strand or the solid gel cut to length is covered with a prefabricated shaped body.

Alternatively or in combination with covering using a shaped body, the dimensionally stable solid gel strand is discharged onto the upper side of a prefabricated shaped body. If the solid gel strand is discharged onto a first prefabricated shaped body and the side opposite the side covered with the first prefabricated shaped body is covered with a second prefabricated shaped body, a sandwich-like detergent portion unit, which is particularly advantageous in terms of handling and optics, is obtained.

The shaped body can be packaged in different ways. The use of casting bodies has proven to be technically easy to implement. The manufacture of the shaped body using casting processes has the advantage that a wide variety of geometries can be produced. The casting bodies are particularly preferably solidified melts.

Due to their ease of manufacture on an industrial scale, extruded bodies, in particular tablets, are particularly preferred as shaped bodies.

Irrespective of the method used for its manufacture, the shaped body preferably has a breaking strength of 50 N to 300 N, in particular of 50 N to 150 N. This breaking strength ensures, on the one hand, that the shaped body is sufficiently stable during production, transport and handling by the consumer and, on the other hand, ensures a satisfactory dissolution behavior of the shaped body in an aqueous liquor. The hardness of the shaped body is measured by deformation of the shaped body until fracture, wherein the force acting on the side surfaces of the shaped body and the maximum force that it withstands is determined. In order to determine the level of shaped body hardness, a tablet testing apparatus from the company Sotax is suitable, for example.

Preferred shaped bodies have a flat upper side, the largest diagonal of which is more than twice, preferably more than 4 times, the height of the shaped body.

The shaped bodies used preferably have a width orthogonal to the conveying direction and parallel to the transport surface, which width corresponds to 90 to 110%, particularly preferably 95 to 105%, of the width of the solid gel strand.

The upper sides of the shaped bodies are preferably angular. Particularly preferred are shaped bodies having an angular upper side and rounded corners.

The embossing elements preferably included by the transport device are advantageously designed such that the solid gel strand can be embossed in a manner adapted to the shape of the shaped body.

It is preferred if the solid gel strand is discharged onto the upper sides of prefabricated molded parts located on the conveying element, which are arranged in series in the conveying direction such that the embossing elements projecting into the conveying path engage in the intermediate space between two shaped bodies arranged one behind the other.

Alternatively or in combination with this embodiment, the upper side of the solid gel strand located on the conveying element can be covered with prefabricated shaped bodies which are arranged in series in the conveying direction such that the embossing elements projecting into the conveying path engage in the intermediate space between two shaped bodies arranged one behind the other.

In preferred method variants, the embossing elements have a triangular cross section parallel to the transport surface, comprising a base side parallel to its corresponding side element and two concave isosceles legs, wherein the shaped body has an angular upper side with rounded corners whose curvature corresponds to the curvature of the concave isosceles legs of the cross section.

If the solid gel strand is discharged onto shaped bodies and/or covered with shaped bodies, it is preferred to cut the solid gel strand to length in the region between two adjacent shaped bodies. Ultrasonic cutting has proven to be a particularly efficient, manageable and trouble-free method.

The shaped bodies are preferably imprinted.

In a preferred embodiment of the detergent portion units, the shaped body also contributes to the active washing and active cleaning effect. Corresponding detergent portion units comprise a shaped body which, based on its total weight, contains more than 40 wt. %, preferably more than 60 wt. %, particularly preferably more than 80 wt. %, of active washing or active cleaning ingredient.

Fragrances form a first group of active washing or active cleaning ingredients integrated in the shaped body. Their incorporation into the shaped body ensures a fragrance experience that can be perceived by the consumer and which cannot be ensured in the same way when the fragrances are incorporated into the solid gel.

Builders constitute a further group of active washing or active cleaning ingredients preferably incorporated in the casing substance, in particular the citrates, zeolites, silicates, and carbonates, preferably in particular the citrates and zeolites. The proportion by weight of said active ingredients with respect to the total weight of the casing substance is preferably 5 to 60 wt. %, in particular 10 to 50 wt. %. Casing substances which contain, based on the total weight thereof, 5 to 60 wt. %, in particular 10 to 50 wt. % of zeolite are particularly preferred. These active substances not only contribute to the washing and cleaning effect as intended, but also improve the contour sharpness and resistance of the imprinted image in the event of the shaped body surface being imprinted.

The use of an active substance from the group of polymeric active washing or active cleaning ingredients, preferably polymeric active washing or active cleaning ingredients from the group of celluloses and cellulose derivatives, anionic or nonionic aromatic polyesters, preferably from the group of celluloses, microcrystalline celluloses, carboxymethyl celluloses, of the anionic or nonionic aromatic polyesters, is also advantageous for the contour sharpness and resistance of the imprinted image. The proportion by weight of said cellulose-based active ingredients with respect to the total weight of the casing substance is preferably 2 to 50 wt. %.

The composition of some preferred detergent portion units can be found in the following tables (amounts given in wt. % based on the total weight of the solid gel or the casing substance, unless otherwise indicated).

| | | | |
|---|---|---|---|
| Formula 1 | Formula 2 | Formula 3 | Formula 4 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Shaped body

| | | | | |
|---|---|---|---|---|
| Builder from the group | 5 to 90 | 50 to 90 | 50 to 80 | 50 to 80 |
| of citrates, zeolites, | | | | |
| silicates, and carbonates | | | | |

| | | | |
|---|---|---|---|
| Formula 6 | Formula 7 | Formula 8 | Formula 9 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from the group | 5 to 90 | 50 to 90 | 50 to 80 | 50 to 80 |
| of citrates, zeolites, | | | | |
| silicates, and carbonates | | | | |
| Cellulose and cellulose | 0.5 to 10 | 1.0 to 8.0 | 1.0 to 5.0 | 1.0 to 5.0 |
| derivatives | | | | |

| Formula | Formula | Formula | Formula |
|---|---|---|---|
| 11 | 12 | 13 | 14 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from the | 10 to 70 | 20 to 60 | 20 to 60 | 30 to 50 |
| group of citrates | | | | |
| and zeolites | | | | |

| Formula | Formula | Formula | Formula |
|---|---|---|---|
| 15 | 16 | 17 | 18 |

Solid gel

| | | | | |
|---|---|---|---|---|
| Total surfactant | 30 to 70 | 40 to 60 | 40 to 60 | 45 to 55 |
| Anionic surfactant | 20 to 40 | 20 to 40 | 25 to 35 | 25 to 35 |
| Alkyl ethoxylate | 15 to 30 | 15 to 30 | 20 to 30 | 20 to 30 |
| Enzyme preparation | 0.2 to 8 | 0.3 to 6 | 0.3 to 6 | 0.3 to 6 |
| Organic solvent | 5 to 30 | 5 to 30 | 10 to 28 | 10 to 28 |
| Water | <20 | 1 to 15 | 2 to 14 | 3 to 13 |
| Gelling agent | 0.1 to 5 | 0.1 to 5 | 0.1 to 2.5 | 0.1 to 2.5 |
| Misc. | up to 100 | up to 100 | up to 100 | up to 100 |

Casing substance

| | | | | |
|---|---|---|---|---|
| Builder from the | 10 to 70 | 20 to 60 | 20 to 60 | 30 to 50 |
| group of citrates | | | | |
| and zeolites | | | | |
| Cellulose and | 0.5 to 10 | 1.0 to 8.0 | 1.0 to 5.0 | 1.0 to 5.0 |
| cellulose derivatives | | | | |

In summary, the following subjects matters, inter alia, are provided by this application:
1. A method for manufacturing a detergent portion unit comprising a dimensionally stable solid gel, said method comprising the steps of:
   i) providing a detergent-containing and gelling agent-containing mixture;
   ii) feeding the detergent-containing and gelling agent-containing mixture to a shaping device;
   iii) passing the detergent-containing and gelling agent-containing mixture through the shaping device such that the surfactant-containing and gelling agent-containing mixture is at least partially solidified in the shaping device and a solid gel strand is formed;
   iv) discharging the solid gel strand from the shaping device and further transporting said strand by means of a transport device comprising:
      b) at least one movable conveying element;
   v) cutting the solid gel strand to length by means of ultrasonic cutting such that a solid gel is formed.
2. The method according to point 1, wherein the detergent-containing and gelling agent-containing mixture contains, based on the total weight thereof, 20 to 60 wt. %, preferably 25 to 55 wt. % and in particular 30 to 50 wt. %, surfactant.
3. The method according to any of the preceding points, wherein the detergent-containing and gelling agent-containing mixture contains, based on the total weight thereof, 15 to 35 wt. %, preferably 20 to 30 wt. %, aqueous-organic solvent.
4. The method according to any of the preceding points, wherein the detergent-containing and gelling agent-containing mixture contains low-molecular-weight gelling agents having a molar mass of up to 2000 g/mol, wherein the proportion by weight thereof with respect to the total weight of the mixture is preferably less than 5 wt. %, preferably 0.1 to 5 wt. %, particularly preferably 0.1 to 2.5 wt. %.
5. The method according to any of the preceding points, wherein the detergent-containing and gelling agent-containing mixture contains low-molecular-weight gelling agents selected from the group of cyclic dipeptides, the cyclic dipeptide derivatives and dibenzylidene sorbitols.
6. The method according to any of the preceding points, wherein the detergent-containing and gelling agent-containing mixture contains dibenzylide sorbitol as a low-molecular-weight gelling agent.
7. The method according to any of the preceding points, wherein the detergent-containing and gelling agent-containing mixture is provided continuously in step i).
8. The method according to any of the preceding points, wherein the detergent-containing and gelling agent-containing mixture has a temperature above 23° C., preferably in the range of 23° C. to 60° C.
9. The method according to any of the preceding points, wherein the detergent-containing and gelling agent-containing mixture is fed continuously to the shaping device in step ii).
10. The method according to any of the preceding points, wherein the time period between the provision of the detergent-containing and gelling agent-containing mixture and its entry into the shaping device is 1 to 60 seconds, preferably 5 to 40 seconds.
11. The method according to any of the preceding points, wherein the detergent-containing and gelling agent-containing mixture is passed continuously through the shaping device in step iii).
12. The method according to any of the preceding points, wherein the detergent-containing and gelling agent-containing mixture is introduced into the shaping device at a filling rate of 20 ml/s to 800 ml/s.
13. The method according to any of the preceding points, wherein the detergent-containing and gelling agent-containing mixture is guided through a supply line before entry into the shaping device, and the cross sectional area of the supply line is identical to the cross sectional area of the shaping device.
14. The method according to any of the preceding points, wherein the detergent-containing and gelling agent-containing mixture is guided through a supply line before entry into the shaping device, and the cross sectional area of the supply line differs from the cross sectional area of the shaping device.
15. The method according to any of the preceding points, wherein the detergent-containing and gelling agent-containing mixture is guided through a supply line before entry into the shaping device, and the cross sectional area of the supply line is smaller than the cross sectional area of the shaping device.
16. The method according to any of the preceding points, wherein the detergent-containing and gelling agent-containing is guided through a supply line before entry into the shaping device, and the cross sectional area of the supply line is greater than the cross sectional area of the shaping device.
17. The method according to any of the preceding points, wherein the surfactant-containing and gelling agent-containing mixture is cooled in step iii).
18. The method according to any of the preceding points, wherein the solid gel strand is discharged continuously from the shaping device in step iv).
19. The method according to any of the preceding points, wherein the transport device moves the solid gel strand at a speed of 0.05 m/s to 3 m/s, preferably of 0.8 to 2.2 m/s.
20. The method according to any of the preceding points, wherein the transport device has a continuous or lamellar conveyor belt or a roller conveyor, preferably a continuous conveyor belt, as a conveying element.
21. The method according to any of the preceding points, wherein the transport device as a conveying element has a modular conveyor belt based on conveying chain links.
22. The method according to any one of the preceding points, wherein the transport device furthermore comprises
   b) two side elements opposite one another and synchronously movable with the movable conveying element,
      and
the conveying element and the side elements form a conveying path on which the solid gel strand is moved by means of the conveying element and is laterally delimited by means of the side element, and
the side elements have embossing elements which project into the conveying path and emboss the surface of the solid gel strand after the solid gel strand has been discharged from the shaping device.
23. The method according to point 22, wherein the side elements are movable synchronously with the conveying element and synchronously with one another.
24. The method according to any of points 22 or 23, wherein the side elements have replaceable embossing elements.
25. The method according to any of points 22 to 24, wherein the embossing elements of the two side elements are arranged opposite one another.
26. The method according to any of points 22 to 25, wherein the conveying path has a width b that is orthogonal to the conveying direction, and the solid gel strand has a width of 0.7 b to 1 b, preferably of 0.85 b to 1 b, in particular of 0.95 b to 1 b, that is orthogonal to the conveying direction and parallel to the transport surface.
27. The method according to any of points 22 to 26, wherein the conveying path has a width b that is orthogonal to the conveying direction, and the embossing elements project from 0.05 b to 0.5 b, preferably from 0.1 b to 0.4 b, particularly preferably from 0.15 b to 0.3 b, into the conveying path.
28. The method according to any of points 22 to 27, wherein the solid gel strand has a height h that is orthogonal to the transport surface, and the embossing elements have a height of 0.8 h to 4 h, preferably of 1 h to 3 h, and in particular of 1.1 to 2 h that is orthogonal to the transport surface.
29. The method according to any of points 22 to 28, wherein the embossing elements taper at least partially in a spatial direction that is orthogonal to the side elements and parallel to the transport surface.
30. The method according to any of points 22 to 29, wherein the embossing elements have a triangular cross section plane parallel to the transport surface.
31. The method according to any of points 22 to 30, wherein the embossing elements have a triangular cross section parallel to the transport surface, comprising a base side parallel to its corresponding side element and two isosceles legs.
32. The method according to any of points 22 to 31, wherein the embossing elements have a triangular cross section parallel to the transport surface, comprising a base side parallel to its corresponding side element and two concave isosceles legs.
33. The method according to any of points 22 to 32, wherein the embossing elements are pulled out of the solid gel strand after a period of 1 to 50 seconds, preferably of 1 to 25 seconds, particularly preferably of 1 to 15 seconds.
34. The method according to any of the preceding points, wherein the solid gel strand is discharged onto the upper side of a prefabricated shaped body located on the conveying element.
35. The method according to any of the preceding points, wherein the discharged solid gel strand or the cut-to-length solid gel is covered with a prefabricated shaped body.
36. The method according to point 34 or 35, wherein the shaped body is present as a casting body.
37. The method according to any of points 34 to 36, wherein the shaped body is present as an extruded body, preferably as a tablet.
38. The method according to any of points 34 to 37, wherein the shaped body has a breaking strength of 50 N to 300 N, in particular of 50 N to 150 N.
39. The method according to any of points 34 to 38, wherein the shaped body has an imprint.
40. The method according to any of points 34 to 39, wherein the shaped body contains, based on its total weight, more than 40 wt. %, preferably more than 60 wt. %, particularly preferably more than 80 wt. %, active washing or active cleaning ingredient.
41. The method according to any of points 34 to 40, wherein the shaped body contains an active washing or active cleaning ingredient from the group of fragrances.
42. The method according to any of points 34 to 41, wherein the shaped body contains an active washing or active cleaning ingredient from the group of builders, in particular at least one active substance from the group of citrates, zeolites, silicates, and carbonates, preferably from the group of citrates and zeolites.
43. The method according to any of points 34 to 42, wherein the shaped body contains a polymeric active washing or active cleaning ingredient, preferably polymeric active washing or active cleaning ingredients from the group of celluloses and cellulose derivatives, anionic or nonionic aromatic polyesters, preferably from the group of celluloses, microcrystalline celluloses, carboxymethyl celluloses, of the anionic or nonionic aromatic polyesters.
44. The method according to any of points 34 to 43, wherein the shaped body comprises a flat upper side, the largest diagonal of which is more than twice, preferably more than four times, the height of the shaped body.
45. The method according to any of points 34 to 44, wherein the shaped body has a width that is orthogonal to the conveying direction and parallel to the transport surface and that corresponds to 90 to 110%, preferably 95 to 105%, of the width of the solid gel strand.
46. The method according to any of points 34 to 45, wherein the shaped body has an angular upper side, preferably an angular upper side with rounded corners.
47. The method according to any of points 34 to 46, wherein the embossing elements have a triangular cross section plane parallel to the transport surface, comprising a base side parallel to its respective side element, and two concave isosceles legs, and the shaped body has an angular upper side with rounded corners whose curvature corresponds to the curvature of the concave isosceles legs of the cross section.
48. The method according to any of points 34 to 47 wherein the solid gel strand is discharged onto the upper sides of prefabricated molded parts located on the conveying element, which are arranged in series in the conveying direction such that the embossing elements projecting into the conveying path engage in the intermediate space between two shaped bodies arranged one behind the other.
49. The method according to any of the preceding points, wherein the solid gel has a weight of from 10 g to 28 g, preferably of from 12 g to 23 g and in particular of from 15 g to 20 g.
50. The method according to any of the preceding points, wherein the ultrasonic blade is guided through the solid gel strand in a direction orthogonal to the conveying direction of the transport device.
51. The method according to any of the preceding points, wherein the ultrasonic blade is guided through the solid gel strand in a direction orthogonal to the underside of the solid gel strand.
52. The method according to any of the preceding points, wherein the ultrasonic blade is guided through the solid gel strand in a direction parallel to the underside of the solid gel strand.
53. The method according to any of the preceding points, wherein the ultrasonic blade has a straight cutting edge.
54. The method according to any of the preceding points, wherein the ultrasonic blade has a curved cutting edge.
55. The method according to any of the preceding points, wherein the cut edge obtained by the ultrasonic cutting has the shape of a plane.
56. The method according to any of the preceding points, wherein the cut edge obtained by the ultrasonic cutting has the shape of a curved surface.
57. The method according to any of points 22 to 56, wherein the solid gel strand is cut to length in the region of the impression.
58. The method according to any of points 34 to 57, wherein the solid gel strand is cut to length in the region between two adjacent molded articles.

1. A method for manufacturing a solid gel unit of detergent, said method comprising:
providing a mixture of a detergent and a gelling agent;
feeding the mixture to a shaping device such that the mixture is at least partially solidified in the shaping device and a solid gel strand is discharged from the shaping device;
transporting said solid gel strand using a transport device;
cutting the solid gel strand to length using an ultrasonic blade to form the solid gel unit.

2. The method of claim 1, wherein the ultrasonic blade is guided through the solid gel strand in a direction orthogonal to a conveying direction of the transport device.

3. The method of claim 1, wherein the ultrasonic blade is guided through the solid gel strand in a direction orthogonal to an underside of the solid gel strand.

4. The method of claim 1, wherein the ultrasonic blade has a straight cutting edge.

5. The method of claim 1, wherein a cut edge obtained by the ultrasonic blade is planar.

6. The method of claim 1, wherein the solid gel strand is discharged onto an upper side of a prefabricated shaped body located on the transport device.

7. The method of claim 1, wherein the discharged solid gel strand is covered with a prefabricated shaped body.

8. The method of claim 1, wherein the solid gel strand is cut to length in a region between two adjacent prefabricated shaped bodies on the transport device.

9. The method of claim 11, wherein the transport device further comprises two side elements opposite one another and synchronously movable with the at least one movable conveying element.

10. The method of claim 13, wherein the solid gel strand is cut to length in the region of the embossed surfaces.

11. The method of claim 1, wherein the transport device comprises at least one movable conveying element.

12. The method of claim 9, wherein the at least one conveying element and the two side elements define a conveying path on which the solid gel strand is transported, and wherein the two side elements laterally delimit the conveying path.

13. The method of claim 12, wherein the two side elements comprise embossing elements that laterally extend into the conveying path, and wherein the two side elements are configured to emboss surfaces of the solid gel strand after the solid gel strand is discharged from the shaping device.

14. The method of claim 1, wherein the solid gel unit is dimensionally stable.

15. The method of claim 1, wherein the mixture comprises a surfactant in an amount of from 20 to 60 wt. % based on the total weight of the mixture.

16. The method of claim 1, wherein the mixture comprises an aqueous-organic solvent in an amount of from 15 to 35 wt. % based on the total weight of the mixture.

17. The method of claim 1, wherein the gelling agent has a molar mass of up to 2000 g/mol, and wherein the gelling agent is in an amount less than 5 wt. % based on the total weight of the mixture.

18. The method of claim 1, wherein the gelling agent is selected from the group consisting of cyclic dipeptides, cyclic dipeptide derivatives, and dibenzylidene sorbitols.

19. The method of claim 18, wherein the gelling agent comprises dibenzylide sorbitol.

20. The method of claim 1, wherein the mixture is provided at a temperature above 23° C.
